(19) United States
(12) Patent Application Publication
(10) Pub. No.: US 2006/0153567 A1
(43) Pub. Date: Jul. 13, 2006

(54) Wavelength-division multiplexing-passive optical network

(75) Inventors: Sang-Ho Kim, Seoul (KR); Chang-Sup Shim, Seoul (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/195,436

(22) Filed: Aug. 2, 2005

(30) Foreign Application Priority Data
Jan. 12, 2005 (KR) 2005-2902

(51) Int. Cl. H04J 14/00

(52) U.S. Cl. 398/72

(57) ABSTRACT

Disclosed is a wavelength-division multiplexing-passive optical network having a central office including a plurality of first working and protection transmit/receive modules, working and protection optical transmitters, and a plurality of first optical switches, the first working and protection transmit/receive modules generating downstream optical signals and detecting upstream optical signals having corresponding wavelengths, the working and protection optical transmitters generating broadcasting optical signals, the first optical switches performing a switching operation when faults occur, a plurality of subscriber units for receiving broadcasting optical signals and downstream optical signals having corresponding wavelengths and generating upstream optical signals, the subscriber units including second optical switches, a remote node including working and protection optical splitters for dividing intensity of the broadcasting optical signals, the remote node being positioned between the subscriber units and the central office, working and protection main optical fibers for linking the central office with the remote node; and a plurality of working and protection branch optical fibers for linking the remote node with the subscriber units, respectively.

### CLAIM OF PRIORITY

This application claims priority to an application entitled “Wavelength-Division Multiplexing-Passive Optical Network,” filed in the Korean Intellectual Property Office on Jan. 12, 2005 and assigned Serial No. 2005-2902, the contents of which are incorporated herein by reference.

### BACKGROUND OF THE INVENTION

1. Field of the Invention

The present invention relates to a passive optical network, and more particularly to a passive optical network capable of performing a protection switch operation.

2. Description of the Related Art

A wavelength division multiplexing-passive optical network (WDM-PON) transmits an optical signal carrying data through a corresponding channel having an intrinsic wavelength that is assigned to each of subscriber units. Accordingly, such a PON has a superior capability for maintaining communication security as compared with other telecommunication networks. In addition, the PON can easily expand communication capacity and is easily adaptable for providing additional communication services required by each subscriber.

The PON described above includes a central office for providing communication services, a plurality of subscriber units for receiving the communication services, and a remote node for relaying optical signals between the central office and the subscriber units. The PON has a double star-type structure linking the central office with the remote node through a single main optical fiber and linking the remote node with the subscriber units through a plurality of branch optical fibers, so that optical fibers may be easily installed and managed.

Since the PON transmits mass storage data at a high speed using an optical signal having an intrinsic wavelength assigned to each subscriber unit, a great amount of data may be lost in a short period of time when a communication failure occurs. For this reason, a PON having a structure having a low-speed communication circuit used for preventing data loss caused by faults has been proposed. In addition, a ring-type network having a protection switch structure is also suggested.

However, the low-speed communication circuit increases costs for the network and requires continuous management and maintenance. Moreover, the low-speed communication circuit requires a great amount of time to repair when a failure occurs. Furthermore, although the structure of the ring-type network is efficient for relaying optical signals between a central office and a plurality of remote nodes, it is difficult for the ring-type network to perform the protection switch function embodied in a PON having a double star-type structure.

### SUMMARY OF THE INVENTION

Accordingly, the present invention has been made to solve the above-mentioned problems occurring in the prior art and provides additional advantages, by providing a wavelength division multiplexing-passive optical network having a protection switch function and capable of transmitting broadcasting signals.

In one embodiment, there is provided a passive optical network including a central office including a plurality of first working and protection transmit/receive modules, working and protection optical transmitters, and a plurality of first optical switches, the first working and protection transmit/receive modules generating downstream optical signals and detecting upstream optical signals having corresponding wavelengths, the working and protection optical transmitters generating broadcasting optical signals, the first optical switches performing a switching operation when a failure occurs, a plurality of subscriber units for receiving broadcasting optical signals and downstream optical signals having corresponding wavelengths and generating upstream optical signals, the subscriber units including second optical switches, a remote node including working and protection optical splitters for dividing the intensity of the broadcasting optical signals, the remote node being positioned between the subscriber units and the central office, working and protection main optical fibers for linking the central office to the remote node, and a plurality of working and protection branch optical fibers for linking the remote node to the subscriber units, respectively.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating a structure of a wavelength division multiplexed passive optical network capable of performing protection switch according to an embodiment of the present invention; and

FIGS. 2 to 6 are block diagrams illustrating a protection switch operation when a failure occurs in the PON shown in FIG. 1.

### DETAILED DESCRIPTION

Hereinafter, embodiments of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted as it may make the subject matter of the present invention unclear.

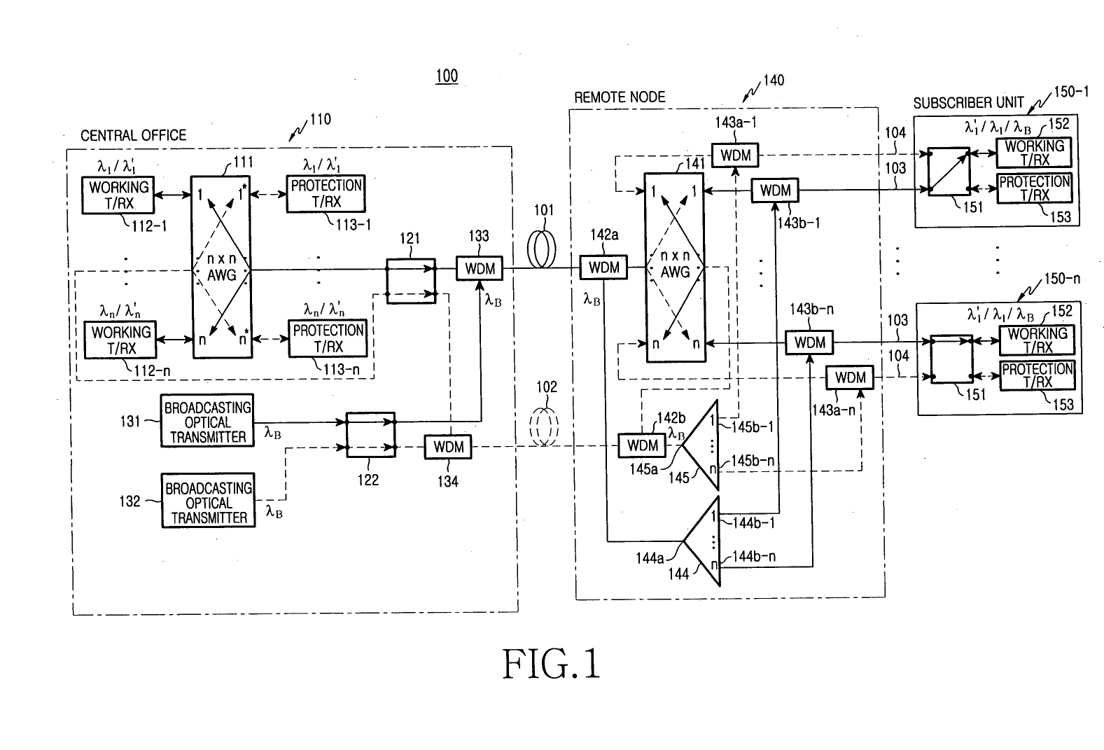

FIGS. 1 to 6 are block diagrams illustrating the structure of the PON 100, wherein a solid line shows an operation state of a corresponding optical signal, and a dotted line shows a non-operation state of a corresponding optical signal.

FIG. 1 is a block diagram illustrating the structure of a wavelength division multiplexed passive optical network (WDM-PON) 100 capable of performing a protection switch operation according to an embodiment of the present invention. The PON 100 includes a central office 110 for generating multiplexed downstream optical signals and broadcasting optical signals and for detecting upstream optical signals, a remote node 140 for multiplexing the upstream optical signals and de-multiplexing the downstream optical signals, a plurality of subscriber units 150-1 to 150-n for receiving broadcasting optical signals and downstream optical signals having corresponding wavelengths, working and protection main optical fibers 101 and 102 for linking the central office 110 to the remote node 140, and a plurality of working and protection branch optical fibers 103 and 104 for linking the remote node 140 to the subscriber units 150-1 to 150-n.

The central office 110 includes first optical switches 121 and 122, protection and working optical transmitters 131 and 132, a plurality of first working transmit/receive modules 112-1 to 112-n, a plurality of first protection transmit/receive modules 113-1 to 113-n, a first multiplexer/de-multiplexer 111, and first working and protection multiplexers 133 and 134. The central office 110 is linked with the remote node 140 through the working and protection main optical fibers 101 and 102.

The protection and working optical transmitters 131 and 132 generate broadcasting optical signals to be output to a corresponding first optical switch 122. The protection and working optical transmitters 131 and 132 can perform a protection switch operation in which the protection optical transmitter 132 is used instead of the working optical transmitter 131 when a failure occurs in a path linked to the working optical transmitter 131.

The first working transmit/receive modules 112-1 to 112-n linked to the first multiplexer/de-multiplexer 111 generate the downstream optical signals to be output to the first multiplexer/de-multiplexer 111 and detect upstream optical signals having corresponding wavelengths de-multiplexed by the first multiplexer/de-multiplexer 111. The first protection transmit/receive modules 113-1 to 113-n are linked to the first multiplexer/de-multiplexer 111 and can perform a protection switch operation in which the first protection transmit/receive modules 113-1 to 113-n are used instead of the first working transmit/receive modules 112-1 to 112-n when a failure occurs in the paths linked to the first working transmit/receive modules 112-1 to 112-n.

The first multiplexer/de-multiplexer 111 includes a plurality of ports 1 to n and 1* to n*. Two more ports of the first multiplexer/de-multiplexer 111 are linked to the corresponding first optical switch 121. Each of the working and protection transmit/receive modules 112-1 to 112-n, and 113-1 to 113-n is linked to the corresponding port of the first multiplexer/de-multiplexer 111.

In other words, the first multiplexer/de-multiplexer 111 multiplexes the downstream optical signals to be output to the remote node 140 and de-multiplexes the multiplexed upstream optical signals so as to output the upstream optical signals to the corresponding first working transmit/receive modules 112-1 to 112-n or the corresponding first protection transmit/receive modules 113-1 to 113.

The first working and protection multiplexers 133 and 134 positioned between the corresponding first optical switches 121 and 122 and the remote node 140 are linked to the first optical switches 121 and 122. The first working multiplexer 133 is linked to the remote node 140 through the working main optical fiber 101, and the first protection multiplexer 134 is linked to the remote node 140 through the protection main optical fiber 102.

The first working multiplexer 133 outputs multiplexed downstream optical signals (received from the first multiplexer/de-multiplexer 111 through the first optical switch 121) to the remote node 140 through the working main optical fiber 101. In addition, the first working multiplexer 133 outputs the upstream optical signals (received from the remote node 140 through the working main optical fiber 101) to the first multiplexer/de-multiplexer 111 through the corresponding optical signal 121.

The first working multiplexer 133 outputs broadcasting optical signals received through the corresponding first optical switch 122 to the remote node 140 via the working main optical fiber 101.

One optical switch 122 of the first optical switches 121 and 122 is positioned between the working and protection optical transmitters 131 and 132 and the first protection multiplexer 134, and the other optical switch 121 is positioned between the first multiplexer/de-multiplexer 111 and the first working multiplexer 133.

The corresponding first optical switch 122 linked to the working and protection optical transmitters 131 and 132 can selectively output broadcasting optical signals through one of the first working and protection multiplexers 133 and 134. The corresponding first optical switch 121 receiving multiplexed upstream optical signals outputs the multiplexed upstream optical signals to the first multiplexer/de-multiplexer 111. In addition, the corresponding first optical switch 121 can selectively output multiplexed downstream optical signals through the first working and protection multiplexers 133 and 134.

The remote node 140 includes a second multiplexer/de-multiplexer 141, working and protection optical splitters 144 and 145, second working and protection multiplexers 142a and 142b, and a plurality of third working and protection multiplexers 143b-1 to 143b-n and 143a-1 to 143a-n. The remote node 140 de-multiplexes multiplexed downstream optical signals so as to output the downstream optical signals to the corresponding subscriber units 150-1 to 150-n. The remote node 140 divides intensities of broadcasting signals so as to output the broadcasting signals to the subscriber units 150-1 to 150-n. In addition, the remote node 140 multiplexes upstream optical signals received from the subscriber units 150-1 to 150-n so as to output the multiplexed upstream optical signals to the central office 110.

The second multiplexer/de-multiplexer 141 de-multiplexes multiplexed downstream optical signals received through the second working or protection multiplexer 142a or 142b and outputs the downstream optical signals to the subscriber units 150-1 to 150-n through corresponding third working multiplexers 143b-1 to 143b-n or corresponding third protection multiplexers 143a1 to 143a-n. In addition, the second multiplexer/de-multiplexer 141 multiplexes upstream optical signals received from the subscriber units 150-1 to 150-n through the third working or protection multiplexers 143b-1 to 143b-n or 143a-1 to 143a-n and outputs the upstream optical signals to the central office 110 through the second working or protection multiplexer 142a or 142b.

The second working multiplexer 142a is linked to the central office 110 through the working main optical fiber 101 and linked to an input port 144a of the working optical splitter 144 and the second multiplexer/de-multiplexer 141. The second protection multiplexer 142b is linked to the central office 110 through the protection main optical fiber 102 and linked to an input port 145a of the protection optical splitter 145 and the second multiplexer/demultiplexer 141.

The second working and protection multiplexers 142a and 142b output multiplexed downstream optical signals received from the central office 110 to the second multiplexer/de-multiplexer 141 and output the upstream optical signals multiplexed in the second multiplexer/de-multiplexer 141 to the central office 110 through the working main fiber 101 or the protection main fiber 102. In addition, the second working or protection multiplexer 142a or 142b outputs broadcasting optical signals received from the central office 110 to the working or protection optical splitter 144 or 145.

The working or protection optical splitter 144 or 145 includes one input port 144a or 145a and a plurality of output ports 144b-1 to 144b-n or 145b-1 to 145b-n and divides the intensities of broadcasting signals received through the second working or protection multiplexer 142a or 142b so as to output the broadcasting signals to corresponding output ports 144b-1 to 144b-n or 145b-1 to 145b-n.

The third working multiplexers 143b-1 to 143b-n are positioned between the second multiplexer/de-multiplexer 141 and the subscriber units 150-1 to 150-n, respectively, and linked to the corresponding subscriber units 150-1 to 150-n through corresponding working branch optical fibers 103. In addition, the third working multiplexers 143b-1 to 143b-n are linked to the corresponding output ports 144b-1 to 144b-n of the working optical splitter 144.

The third working multiplexers 143b-1 to 143b-n output downstream optical signals having corresponding wavelengths (received from the second multiplexer/de-multiplexer 141) to the corresponding subscriber units 150-1 to 150-n and output upstream optical signals (generated from the corresponding subscriber units 150-1 to 150-n) to the second multiplexer/de-multiplexer 141. In addition, the third working multiplexers 143b- 1 to 143b-n output broadcasting optical signals divided in the working optical splitter 144 to the corresponding subscriber units 150-1 to 150-n, respectively.

The third protection multiplexers 143a-1 to 143a-n are positioned between the second multiplexer/de-multiplexer 141 and the corresponding subscriber units 150-1 to 150-n and linked to the corresponding subscriber units 150-1 to 150-n through the corresponding protection branch optical fibers 104. In addition, the third protection multiplexers 143a-1 to 143a-n are linked to the protection optical splitter 145.

The subscriber units 150-1 to 150-n receive downstream optical signals having corresponding wavelengths and broadcasting optical signals through the remote node 140 or generate upstream optical signals to the remote node 140. Each of the subscriber units 150-1 to 150-n includes a second optical switch 151 and second working and protection transmit/receive modules 152 and 153.

The second optical switch 151 includes four ports, two ports of the four ports are linked to the corresponding working and protection branch optical fibers 103 and 104, respectively, and remaining ports are linked to the second working and protection transmit/receive modules 152 and 153, respectively. The second optical switch 151 selectively links the second working transmit/receive module 152 or the second protection transmit/receive module 153 with the remote node 140.

The second working or protection transmit/receive module 152 or 153 detects a downstream optical signal having a corresponding wavelength received from the remote node 140 through the second optical switch 151 or generates an upstream optical signal so as to output the upstream optical signal to the remote node 140 through the second optical switch 151.

The second working or protection transmit/receive module 152 or 153 may include a light source for generating the upstream optical signal and an optical detector for detecting a downstream optical signal having a corresponding wavelength. The second working or protection transmit/receive module 152 or 153 may employ a photo diode as the optical detector.

The downstream optical signals have a wavelength band different from that of the upstream optical signals. In other words, the downstream optical signals have a wavelength band of λ₁ to λₙand the upstream optical signals have a wavelength band of λ_{1′} to λ_{n′}. A wavelength of λB represents a broadcasting optical signal.

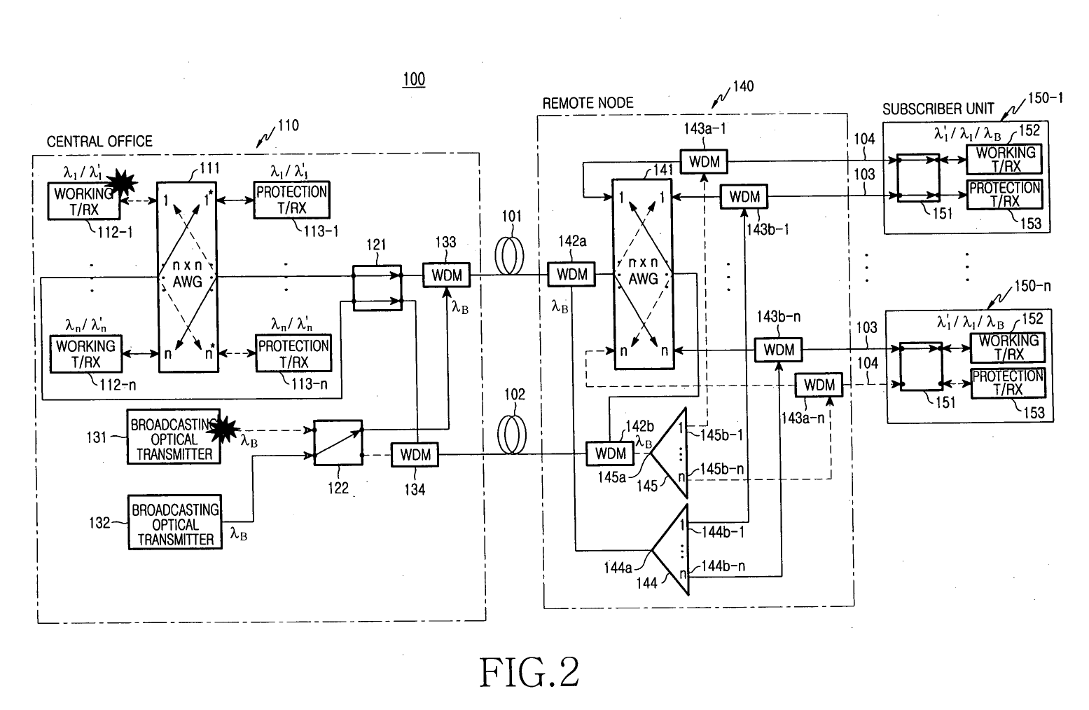

FIGS. 2-6 is a block diagram illustrating a protection switch operation of the PON 100 when faults occur in the first working transmit/receive module 112-1 and the working optical transmitter 131.

Referring to FIG. 2, which illustrates the operation steps when faults occur in the first working transmit/receive module 112-1 and the working optical transmitter 131, the corresponding protection transmit/receive module 113-1 generates a downstream optical signal and detects an upstream optical signal having a corresponding wavelength instead of the corresponding working transmit/receive module 112-1 having a fault.

The first multiplexer/de-multiplexer 111 de-multiplexes multiplexed upstream optical signals received through the first working multiplexer 133 and the corresponding first optical switch 122 and outputs the upstream optical signals having corresponding wavelengths to the remaining working transmit/receive modules 112-2 to 112-n except for the working transmit/receive module 112-1 having faults, respectively. The first multiplexer/de-multiplexer 111 outputs an upstream optical signal having a corresponding wavelength (received through the first protection multiplexer 134) to the corresponding first protection transmit/receive modules 113-1 performing a protection switch operation or outputs a downstream optical signal generated from the corresponding first protection transmit/receive module 113-1 to the remote node 140 through the first protection multiplexer 134.

The protection optical transmitter 132 generates broadcasting optical signals instead of the working optical transmitter 131, and the generated broadcasting optical signals are output to the remote node 140 through the corresponding first optical switch 122 and the first working multiplexer 133.

The second protection multiplexer 142b of the remote node 140 outputs a downstream optical signal generated from the corresponding first protection transmit/receive module 113-1 to the second multiplexer/de-multiplexer 141 or outputs an upstream optical signal having a corresponding wavelength received from the second multiplexer/de-multiplexer 141 to the first protection multiplexer 134 of the central office 110.

An upstream optical signal to be output to the corresponding first working transmit/receive module 112-1 (having faults) of the central office 110 is input to the second multiplexer/de-multiplexer 141 through the corresponding third protection multiplexer 143b-1 of the remote node 140. The second multiplexer/de-multiplexer 141 outputs a corresponding upstream optical signal (received from the corresponding third protection multiplexer 143a-1) to the central office 110 through the second protection multiplexer 142b.

The first multiplexer/de-multiplexer 111 de-multiplexes multiplexed upstream optical signals received through the working main optical fiber 101 so as to output the upstream optical signals to the corresponding first working transmit/receive modules 112-2 to 112-n and outputs an upstream optical signal having a corresponding wavelength received through the protection main optical fiber 102 to the first protection transmit/receive module 113-1. In contrast, a downstream optical signal generated in the first protection transmit/receive module 113-1 is output to the remote node 140 through the protection main optical fiber 102.

The protection optical transmitter 132 generates broadcasting optical signals, and the broadcasting optical signals are output to the remote node 140 through the corresponding first optical switch 122, the corresponding first working multiplexer 133, and the working main optical fiber 101, etc.

The second working multiplexer 142a outputs only the broadcasting optical signals from among the broadcasting optical signals and multiplexed downstream optical signals (received through the working main optical fiber 101) to the working optical splitter 144 and outputs the multiplexed downstream optical signals to the second multiplexer/de-multiplexer 141.

In sum, FIG. 2 illustrates a protection switch operation when faults occur in the specific working transmit/receive module 112-1 and the working optical transmitter 131 of the central office 110. The passive optical network (PON) 100 shown in FIG. 2 employs the working optical fiber 101 together with the protection optical fiber 102 and operates the corresponding protection transmit/receive module 113-1, thereby enabling continuous supply of a downstream optical signal having a corresponding wavelength to the corresponding subscriber unit 150-1. In addition, the PON 100 shown in FIG. 2 operates the protection optical transmitter 132 instead of the working optical transmitter 131, thereby enabling a continuous supply of broadcasting optical signals to the subscriber units 150-1 to 150-n.

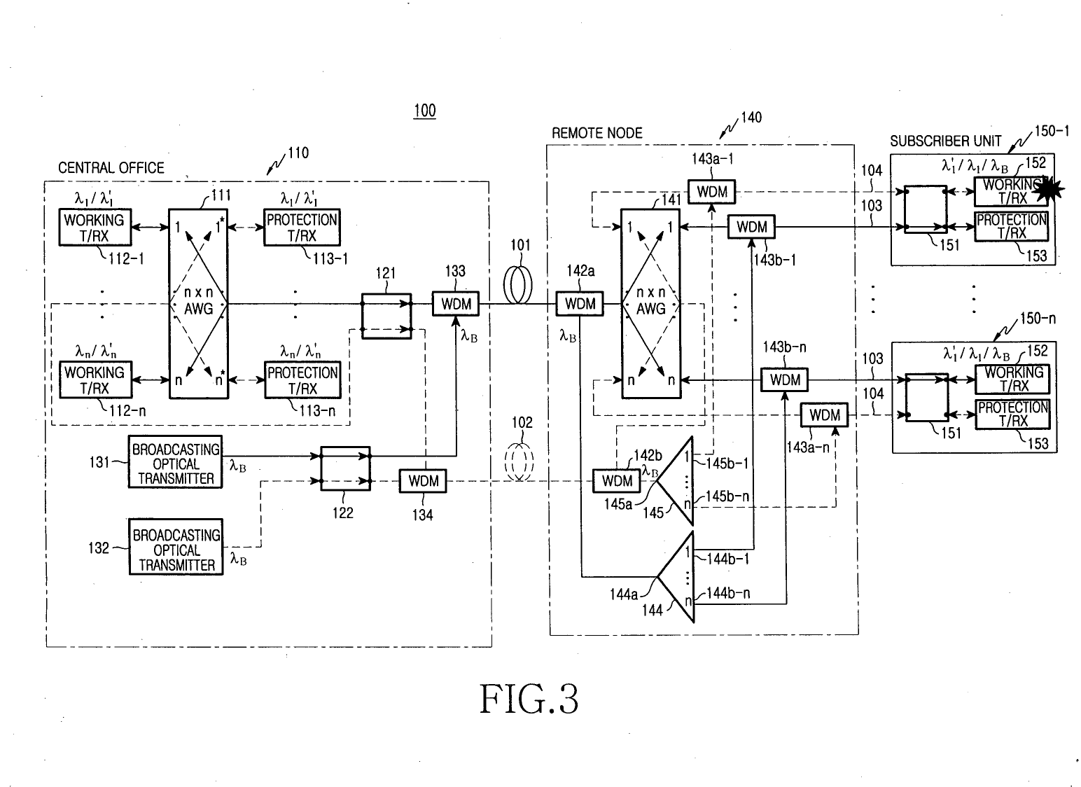

FIG. 3 illustrates a protection switch operation when faults occur in the second working transmit/receive module 152 of the specific subscriber unit 150-1. In this scenario, the second protection transmit/receive module 153 operates instead of the second working transmit/receive module 152.

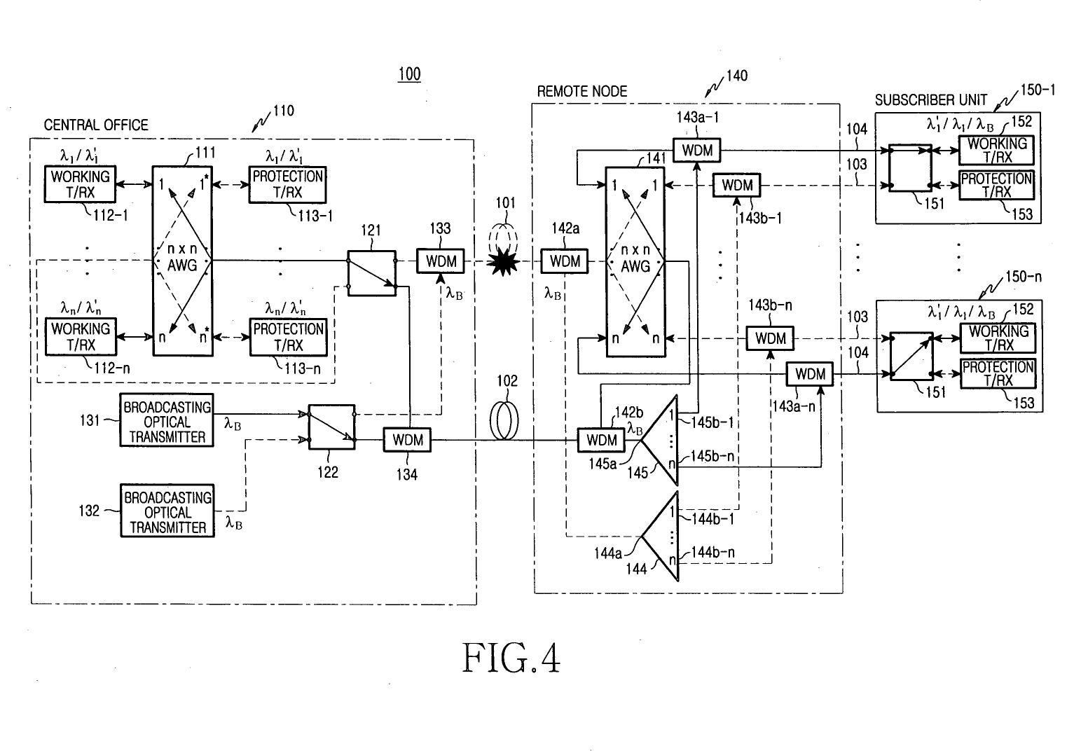

FIG. 4 illustrates a protection switch operation in the PON 100 when faults occur in the working main optical fiber 101. Here, the protection main optical fiber 102 is used instead of the working main optical fiber 101. The central office 110 inputs/outputs upstream or downstream optical signals multiplexed through the first protection multiplexer 134 instead of the first working multiplexer 133.

The remote node 140 receives downstream optical signals multiplexed through the second protection multiplexer 142b or outputs multiplexed upstream optical signals to the central office 110.

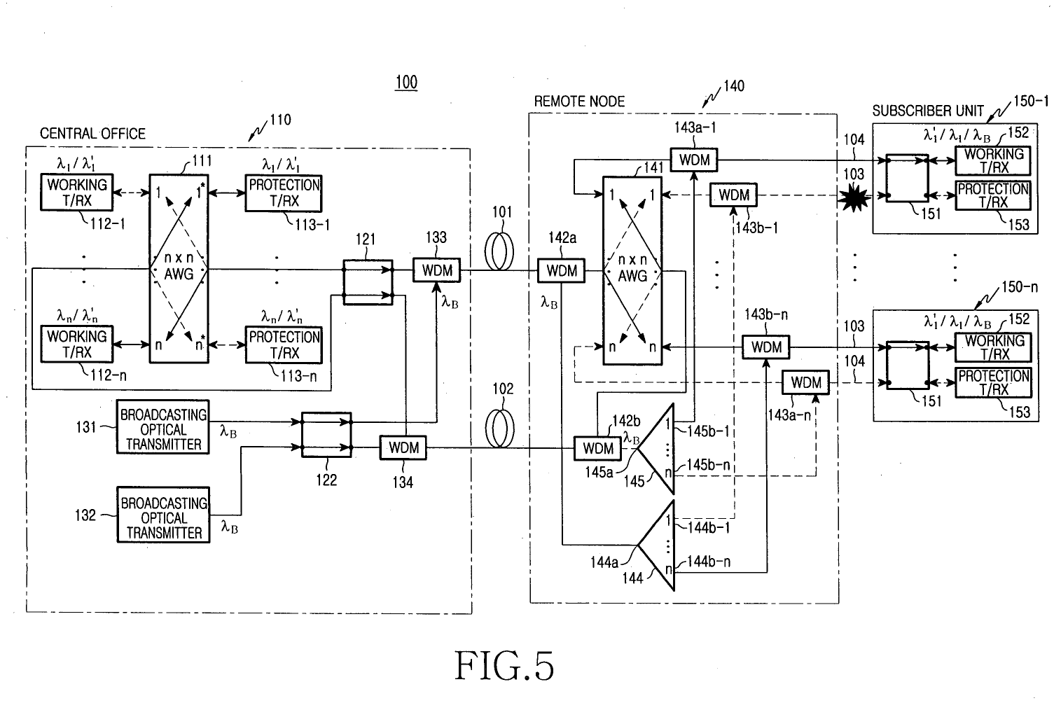

FIG. 5 illustrates a protection switch operation in the PON 100 when faults occur in the specific working branch optical fiber 103. Here, the protection branch operation fiber 104 is used instead of the working branch operation fiber 103 having faults. The protection optical splitter 145 receives broadcasting optical signals through the second protection multiplexer 142b, divides the intensities of the received broadcasting optical signals, and then outputs the intensity-divided broadcasting optical signal to the corresponding subscriber unit 150-1 (linked with the working branch optical fiber 103 having faults) through the corresponding protection branch optical fiber 104.

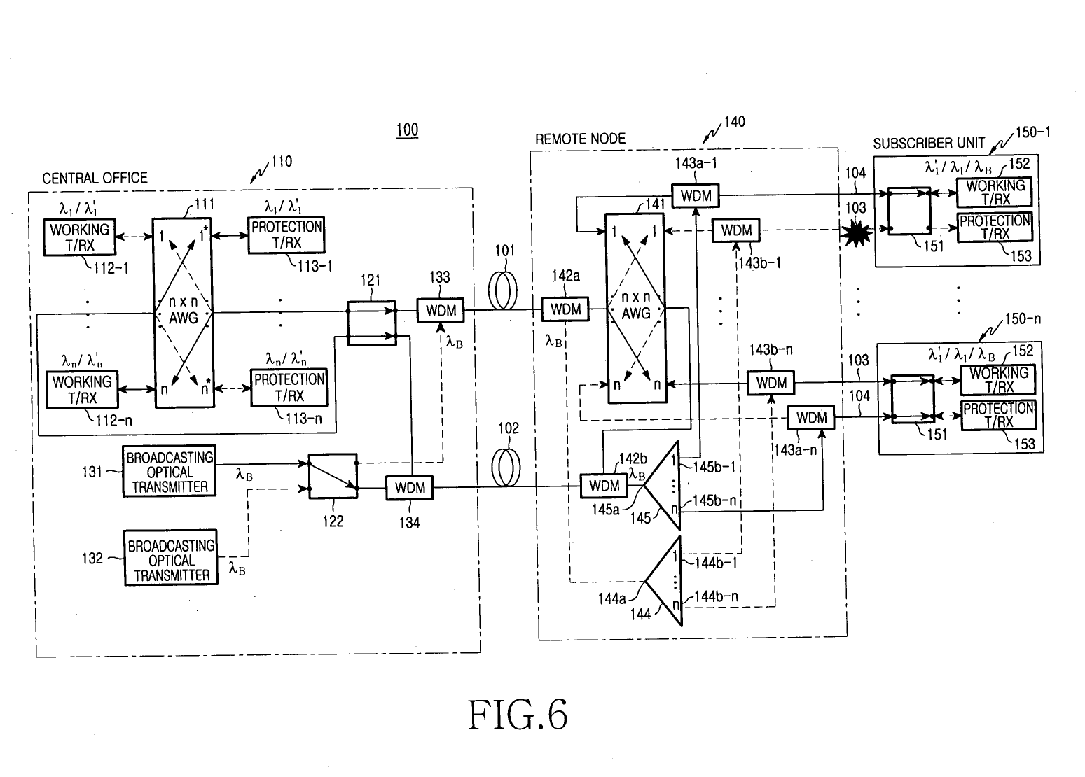

FIG. 6 illustrates a protection switch operation in the PON 100 when faults occur in the specific working branch optical fiber 103 similarly to FIG. 5. In the PON 100 shown in FIG. 6, the working optical splitter 144 is completely substituted with the protection optical splitter 145.

As described above, the present invention relates to a passive optical network integrating a broadcasting optical path with a communication optical path. According to the present invention, the passive optical network includes protection switch units capable of performing a recovery operation for themselves when faults occur, thereby preventing the occurrence of data loss due to delay of recovery time required when faults are caused.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

WHAT IS CLAIMED IS:

1. A passive optical network comprising:
a central office having a plurality of first working and protection transmit/receive modules for generating downstream optical signals and detecting upstream optical signals, a plurality of working and protection optical transmitters for generating broadcasting optical signals, and a plurality of first optical switches for performing a switching operation when a link failure occurs;
a plurality of subscriber units for receiving broadcasting optical signals and downstream optical signals and generating upstream optical signals, the subscriber units including second optical switches; and
a remote node including working and protection optical splitters for dividing intensity of the broadcasting optical signals and disposed between the subscriber units and the central office.

2. The passive optical network as claimed in claim 1, further comprising working and protection main optical fibers for linking the central office with the remote node; and
a plurality of working and protection branch optical fibers for linking the remote node with the subscriber units, respectively.

3. The passive optical network as claimed in claim 1, wherein the central office further comprises:
a first multiplexer/demultiplexer for multiplexing the downstream optical signals and de-multiplexing multiplexed upstream optical signals so as to output the upstream optical signals to the corresponding first working and protection transmit/receive modules; and
first working and protection multiplexers linked to the working and protection main optical fibers, respectively, and disposed between the corresponding first optical switches and the remote node,
wherein the first multiplexer/de-multiplexer includes a plurality of ports, two ports or more of the first multiplexer/de-multiplexer are linked to the corresponding first optical switch, and each of the first working and protection transmit/receive modules is linked with the corresponding port of the first multiplexer/de-multiplexer.

4. The passive optical network as claimed in claim 1, wherein the working and protection optical transmitters are linked to the corresponding first optical switches, respectively.

5. The passive optical network as claimed in claim 3, wherein the first working and protection multiplexers are linked to the remote node and the first optical switches.

6. The passive optical network as claimed in claim 1, wherein the remote node further comprises:
a second multiplexer/de-multiplexer for multiplexing the upstream optical signals and de-multiplexing multiplexed downstream optical signals so as to output the downstream optical signals to the corresponding subscriber units;
a second working multiplexer linked to the central office through the working main optical fiber and linked to an input port of the working optical splitter and the second multiplexer/de-multiplexer;
a second protection multiplexer linked to an input port of the protection optical splitter and the second multiplexer/de-multiplexer and linked to the central office through the protection main optical fiber; and
third working and protection multiplexers disposed between the second multiplexer/de-multiplexer and the corresponding subscriber units and linked to corresponding output ports of the optical splitters.

7. The passive optical network as claimed in claim 1, wherein each of the subscriber units further comprises second working and protection transmit/receive modules, the second working and protection transmit/receive modules being linked to the corresponding second optical switch, the second working and protection transmit/receive modules detecting a downstream optical signal having a corresponding wavelength and generating an upstream optical signal.

8. The passive optical network as claimed in claim 1, wherein the working optical splitter comprises:
an input port for receiving the broadcasting signals; and
a plurality of output ports for intensity-dividing the broadcasting signals to be output.

9. The passive optical network as claimed in claim 1, wherein the protection optical splitter comprises:
an input port for receiving the broadcasting signals; and
a plurality of output ports for intensity-dividing the broadcasting signals to be output.
